(19) United States
(12) Patent Application Publication
(10) Pub. No.: US 2026/0099903 A1
(43) Pub. Date: Apr. 9, 2026

(54) METHOD AND APPARATUS FOR AUTOMATING PERSONALIZED ARTIFICIAL INTELLIGENCE IMAGE EDITING

(71) Applicant: ELECTRONICS AND TELECOMMUNICATIONS RESEARCH INSTITUTE, Daejeon (KR)

(72) Inventor: Jin SEONG, Daejeon (KR)

(21) Appl. No.: 19/058,454

(22) Filed: Feb. 20, 2025

(30) Foreign Application Priority Data
Oct. 4, 2024 (KR) 10-2024-0134595

(51) Int. Cl. G06T 5/70; G06F 40/284; G06T 11/00

(52) U.S. Cl. CPC G06T 5/70; G06F 40/284; G06T 11/00

(57) ABSTRACT

Provided is a method and apparatus for automating personalized artificial intelligence (AI) image editing, which can generate an output into which a personal style of a user is incorporated when an image is edited by incorporating editing requirements of the user. The method includes an input step of receiving an input image and an user edit instruction from a user terminal, a personalized text encoding step of converting the user edit instruction into a personalized image editing command into which personal characteristics and preference have been incorporated, a personalized denoising step of generating an output image by editing the input image by incorporating the personalized image editing command, and an output step of outputting an edited output image.

### CROSS-REFERENCE TO RELATED APPLICATION(S)

This application claims priority from and the benefit of Korean Patent Application No. 10-2024-0134595, filed on Oct. 4, 2024, which is hereby incorporated by reference for all purposes as if set forth herein.

### BACKGROUND

### 1. Technical Field

The present disclosure relates to a method and apparatus for automating personalized artificial intelligence image editing.

### 2. Description of Related Art

There are proposed various artificial intelligence (AI)-based technologies which enable an image to be modified based on a user input. For example, an AI-based technology, such as GPT4-V, may generate an image based on caption provided by a user, but has a limited function for modifying an image based on a user's intention. In particular, when a minute modification is necessary, it is difficult to satisfy detailed requirements of a user by only the technology.

The automatic AI coloring technique of Naver Webtoon enables automatic coloring through one touch painting, but is required to specifically designate a specific inpainting area and color corresponding to a part that is desired to be colored by a user, and has a problem in that it is difficult to add details to a drawing due to an automated process. Furthermore, the automatic AI coloring technique requires a model that is directly trained by a drawing drawn by a user in order to incorporate a personal style of the user.

A Prompt-to-prompt (Amir Hertz, Ron Mokady, Jay Tenenbaum, Kfir Aberman1, Yael Pritch, and Daniel Cohen-Or, Prompt-to-Prompt Image Editing with Cross Attention Control. In arXiv:2208.01626[cs.CV], 2022.) technique enables the modification of an original image through text by overcoming the limits of the existing diffusion-based image generation model. However, this method is constrained by the requirement that only partial modifications to the text can be made while preserving the original caption, and the original image also needs to be generated using the same diffusion model.

An Instruct Pix2Pix (Tim Brooks, Aleksander Holynski, and Alexei A. Efros. InstructPix2Pix: Learning to Follow Image Editing Instructions. In arXiv:2211.09800v2[cs.CV], 2023.) provides a technique that edits an image based on a simple command of a user, which is written in a natural language, but has limitations because a personal picture style of a user is never incorporated. In particular, an image editing instruction that is generated by a language model, such as GPT, is realized through a diffusion model. An Instruct Pix2Pix model basically learns a generalized image style through an instruction and image described as described above. Accordingly, a command and image generated as described above do not incorporate a user's individual requirements or style. This shows a problem in that personalized instructions are not sufficiently incorporated in an image editing process because learning data are limited to a specific diffusion model.

### SUMMARY

Various embodiments are directed to providing a method and apparatus for automating personalized artificial intelligence (AI) image editing, which can generate an output into which a personal style of a user is incorporated when an image is edited by incorporating editing requirements of the user.

An apparatus for automating personalized artificial intelligence image editing according to an embodiment of the present disclosure includes an input/output (I/O) module configured to receive an input image and a user edit instruction from a user terminal and to output an edited output image, a personalized text encoder configured to convert the user edit instruction into a personalized image editing command into which personal characteristics and preference have been incorporated, and a personalized denoising model configured to generate an output image by editing the input image by incorporating the personalized image editing command.

In an embodiment, the personalized text encoder includes a text encoder being a model that understands common text and configured to convert the user edit instruction into the image editing command that is used in the apparatus, and a personalized text encoder adapter configured to store parameters of personal command styles and to embed, in the image editing command, the personalized editing command into which the personal characteristics and preference have been incorporated.

In an embodiment, the personalized denoising model includes a personalized denoising adapter configured to store user information into which a style or preference of a user have been incorporated, and a denoising model configured to perform noise removal and image restoration based on the personalized image editing command and the user information.

In an embodiment, the text encoder includes a tokenizer and embedder configured to tokenize and embed the user edit instruction, a multi-head attention layer configured to extract important information by simultaneously analyzing text of various parts, an adding and normalization layer configured to add and normalize results extracted in the multi-head attention layer, a feedforward layer configured to perform more complicated text interpretation, an adding and normalization layer configured to add and normalize results in the feedforward layer.

In an embodiment, the personalized text encoder includes a tokenizer and embedder configured to tokenize and embed the user edit instruction, a user edit instruction embedding configured to convert the tokenized and embedded user edit instruction of a user in an intermediate embedding form in order to understand a meaning of text, a Pre-trained weights unit configured to perform common text processing on an output of the user edit instruction embedding by using an image-text understanding model, a personal weight unit configured to embed, as personalized text data, the output of the user edit instruction embedding through an additional adapter layer that incorporates a style and preference of a user, and a hidden embedding configured to integrate data processed by the Pre-trained weights and the personal weight.

In an embodiment, the personalized text encoder includes a tokenizer and embedder configured to tokenize and embed the user edit instruction, a user edit instruction embedding configured to convert the tokenized and embedded user edit instruction of a user in an intermediate embedding form in order to understand a meaning of text, a Pre-trained weights configured to perform common text processing on an output of the user edit instruction embedding by using an image-text understanding model, a projection-up layer and a projection-down layer each configured to have a low-rank adaptation of large language models (LORA) technology applied thereto and to further subdivide and personalize a text embedding, and a hidden embedding configured to integrate the generated embeddings.

In an embodiment, the denoising model includes an image encoder configured to convert an image in a pixel space into an image in a latent space, a forward denoising unit configured to gradually apply noise to the converted image in the latent space, a reverse denoising unit configured to restore the image output by the forward denoising unit to an image into which the personalized image editing command and the user information have been incorporated through a cross-attention mechanism, and a decoder configured to convert the image output by the reverse denoising unit into an image in the pixel space.

In an embodiment, the reverse denoising unit outputs the image in a state in which the image substantially does not include noise by repeating a step of reducing the noise in the image a predetermined number of times or more.

In an embodiment, the denoising model may be trained to have a personalization editing ability through a process including steps of initializing the trained denoising model, adding noise to an input image provided by the user, removing noise and restoring an image based on the user edit instruction and personal style information, comparing the restored image with an existing correct answer image, and updating the denoising model based on results of the comparison.

A method of automating personalized artificial intelligence image editing according to an embodiment of the present disclosure includes an input step of receiving an input image and a user edit instruction from a user terminal, a personalized text encoding step of converting the user edit instruction into a personalized image editing command into which personal characteristics and preference have been incorporated, a personalized denoising step of generating an output image by editing the input image by incorporating the personalized image editing command, and an output step of outputting an edited output image.

In an embodiment, the personalized text encoding step includes a text encoding step of converting the user edit instruction into an image editing command that is used in an apparatus as a model that understands common text, and a step of embedding, in the image editing command, the personalized editing command into which personal characteristics and preference have been incorporated by using a personalized text encoder adapter in which parameters of a personal command style are stored.

In an embodiment, the personalized denoising step may include performing noise removal and image restoration, based on user information stored in a personalized denoising adapter in which the user information having a style or preference of a user incorporated therein is stored and the personalized image editing command.

In an embodiment, the text encoding step includes a tokenizing and embedding step of tokenizing and embedding the user edit instruction, a multi-head attention step of extracting important information by simultaneously analyzing text of various parts, an adding and normalization step of adding and normalizing results extracted in the multi-head attention step, a feedforward step of performing more complicated text interpretation, and an adding and normalization step of adding and normalizing results in the feedforward step.

In an embodiment, the personalized text encoding step includes a tokenizing and embedding step of tokenizing and embedding the user edit instruction, a user edit instruction embedding step of converting the tokenized and embedded user edit instruction of a user in an intermediate embedding form in order to understand a meaning of text, a step of performing common text processing on an output of the user edit instruction embedding step based on a Pre-trained weights by using an image-text understanding model, a step of embedding the output of the user edit instruction embedding step as personalized text data based on a personal weight through an additional adapter layer that incorporates a style and preference of the user, and a hidden embedding step of integrating data processed based on the Pre-trained weights and the personal weight.

In an embodiment, the personalized text encoding step includes a tokenizing and embedding step of tokenizing and embedding the user edit instruction, a user edit instruction embedding step of converting the tokenized and embedded user edit instruction of a user in an intermediate embedding form in order to understand a meaning of text, a step of performing common text processing on an output of the user edit instruction embedding step based on a Pre-trained weights by using an image-text understanding model, a projection-up and projection-down step of further subdividing and personalizing a text embedding by applying a low-rank adaptation of large language models (LORA) technology, and a hidden embedding step of integrating generated embeddings.

In an embodiment, the personalized denoising step includes an image encoding step of converting an image in a pixel space into an image in a latent space, a forward denoising step of gradually applying noise to the image converted in the latent space, a reverse denoising step of restoring the image output from the forward denoising step to an image into which the personalized image editing command and the user information have been incorporated through a cross-attention mechanism, and a decoding step of converting the image output from the reverse denoising unit into an image in a pixel space.

In an embodiment, the reverse denoising step may include outputting an image in a state in which the image substantially does not include noise by repeating a step of reducing the noise in the image a predetermined number of times or more.

In an embodiment, the personalized denoising step is performed by using a denoising model. The denoising model is trained to have a personalization editing ability through a process including steps of initializing the trained denoising model, adding noise to an input image provided by a user, removing the noise and restoring an image based on the user edit instruction and personal style information, comparing the restored image with an existing correct answer image, and updating the denoising model based on results of the comparison.

According to the embodiments of the present disclosure, it is possible to generate an output into which a unique style and intention of a user have been accurately incorporated. Furthermore, a high-quality creation into which a person's individuality has been incorporated can be produced because an image into which a personal style has been incorporated can be generated. Furthermore, according to the embodiments of the present disclosure, the creative process of artists can be dramatically shortened and improved.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 illustrates a schematic operation flow of a method of automating personalized artificial intelligence image editing according to an embodiment of the present disclosure.

FIG. 2 is a functional block diagram illustrating internal components of an image editing system according to an embodiment of the present disclosure.

FIG. 3 illustrates an image editing process according to an embodiment of the present disclosure.

FIG. 4 illustrates a personalized text encoding process according to an embodiment of the present disclosure.

FIG. 5 illustrates a personalized text encoding process using an adapter according to an embodiment of the present disclosure.

FIG. 6 illustrates a personalized text encoding process to which a tunable model has been applied according to an embodiment of the present disclosure.

FIG. 7 illustrates an image denoising process according to an embodiment of the present disclosure.

FIG. 8 illustrates a reverse denoising process according to an embodiment of the present disclosure.

FIG. 9 illustrates a process of training a denoising model according to an embodiment of the present disclosure.

FIG. 10 exemplarily illustrates a concept in which personalized image editing is realized by using an image and a user edit instruction provided by a user according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

In an embodiment of the present disclosure, a user-personalized adapter layer is introduced into the existing automatic image editing technology based on a natural language command. The user-personalized adapter layer effectively learns a personal picture style and an instruction pattern, and may apply the personal picture style and the instruction pattern to image editing upon inference. For example, the user-personalized adapter layer receives a sketch and natural language instruction of a user, and may allow an output into which a unique style and intention of the user have been accurately incorporated to be generated. In an embodiment of the present disclosure, picture characteristics (e.g., color preference, a brush scheme, and lighting treatment) and an instruction use pattern of an individual artist are analyzed in depth and learnt. Accordingly, a more elaborated and personalized image can be generated and edited compared to the existing technology, and a user's creative intention can be implemented more accurately.

Hereinafter, embodiments of the present disclosure are described in detail with reference to the accompanying drawings.

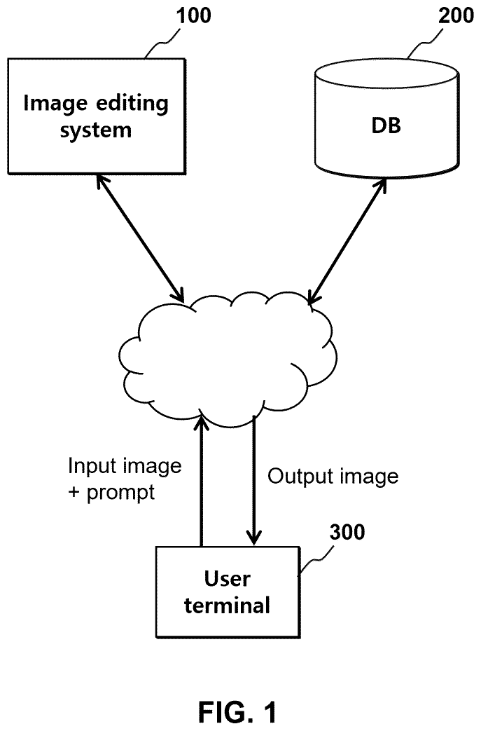

FIG. 1 illustrates a schematic operation flow of a method of automating personalized artificial intelligence image editing according to an embodiment of the present disclosure. A user terminal 300 transmits an input image and a text prompt to an image editing system 100 through a cloud. The input image may be a picture sketched by a user, a draft image, or a captured photo image. The prompt includes a user edit instruction that instructs detailed contents of image editing. The image editing system 100 performs personalized image editing on the input image received from the user terminal 300 based on the user edit instruction included in the prompt, and finally transmits an edited output image to the user terminal 300. According to an embodiment, the image editing system 100 may perform an image editing task by using external database (DB) 200.

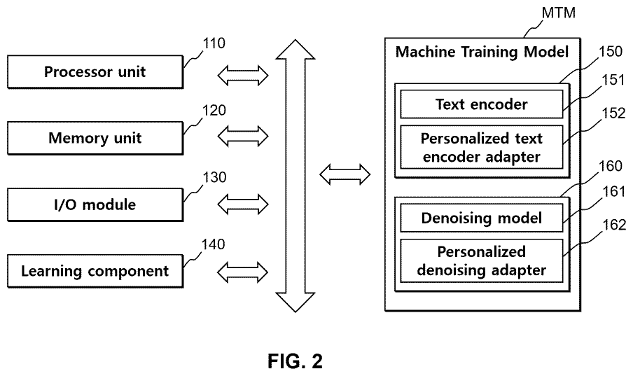

FIG. 2 is a functional block diagram illustrating internal components of the image editing system 100 according to an embodiment of the present disclosure. The image editing system is a solution in which a technique that provides personalized image editing based on a user input (or an image and text instruction) has been integrated. A major object of the image editing system 100 is to generate an edited image into which creative intention and a personal style of a user are precisely incorporated.

A processor unit 110 is responsible for all types of data processing and command execution. A memory unit 120 stores image data, command prompts, user setting, and other necessary information. An input and output (I/O) module 130 that is responsible for an interface with a user processes data that are input to the image editing system, and transmits a final edited image to the user terminal 300. Furthermore, the I/O module 130 manages the exchange of data with the external 200 or a cloud service. A learning component 140 consistently improves the editing ability of the image editing system by using a machine learning algorithm. The learning component enables more accurate and personalized image editing by learning the feedback and editing style of a user.

A machine training model (MTM) includes a personalized text encoder 150 and a personalized denoising model 160. The personalized text encoder 150 includes a text encoder 151, that is, a model that understands common text, and a personalized text encoder adapter 152 in which parameters of personal command styles are stored.

The personalized text encoder 150 analyzes a text instruction (or a user edit instruction) included in a prompt so that the text instruction is accurately changed into an image editing command that is used in the image editing system. Such analysis is essential in defining the details of editing to be applied to an image through text. Furthermore, the personalized text encoder 150 embeds a personalized editing command into which personal characteristics and preference have been incorporated in the image editing command.

The personalized denoising model 160 includes a denoising model 161 and a personalized denoising adapter 162. The personalized denoising model 160 includes a function for editing an image, while gradually restoring noise applied to the image, based on an image editing command that is output from the personalized text encoder 150, and finally generates an edited image into which a picture style of a user has been incorporated. The personalized denoising model 160 provides an output that complies with an artistic goal of a user by removing or modifying an unwanted element in an input image.

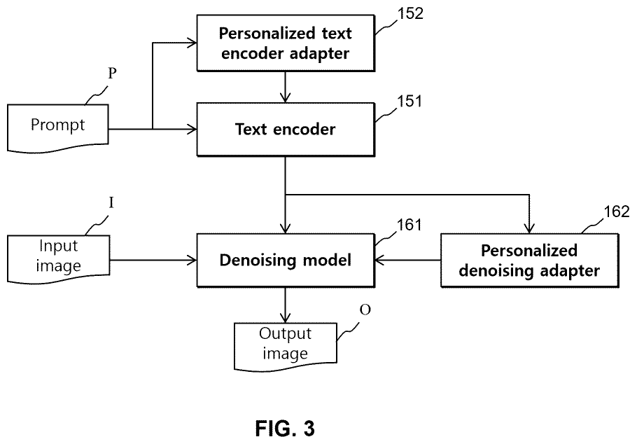

FIG. 3 illustrates an image editing process according to an embodiment of the present disclosure. FIG. 3 schematically illustrates a process of automatically generating an image personalized for a personal style by using a prompt and an image to be edited, which are provided by a user, as an input.

A prompt P including a user user edit instruction is processed and vectorized through the text encoder 151, that is, a model that understands common text, and the personalized text encoder adapter 152 in which parameters of personal command styles are stored. The vectorized text command includes a personalized command.

As described above, the vectorized text command simultaneously applies cross-attention to the denoising model 161 and the personalized denoising adapter 162 in order to incorporate a personal editing command into an image when the image is generated, and determines which part of the image will be focused and edited compared to an input image I. Accordingly, a noise removal model is personalized and adjusted by the personalized denoising adapter 162, and finally generates an edited output image O into which the personal editing command has been incorporated.

An image editing process illustrated in FIG. 3 includes providing more elaborated and personalized image editing results by incorporating a creative demand and personal drawing preferences of a user. Through such a process, a user can adjust a specific part of an image based on a text instruction, which enables intuitive and automated image editing by a text-based command.

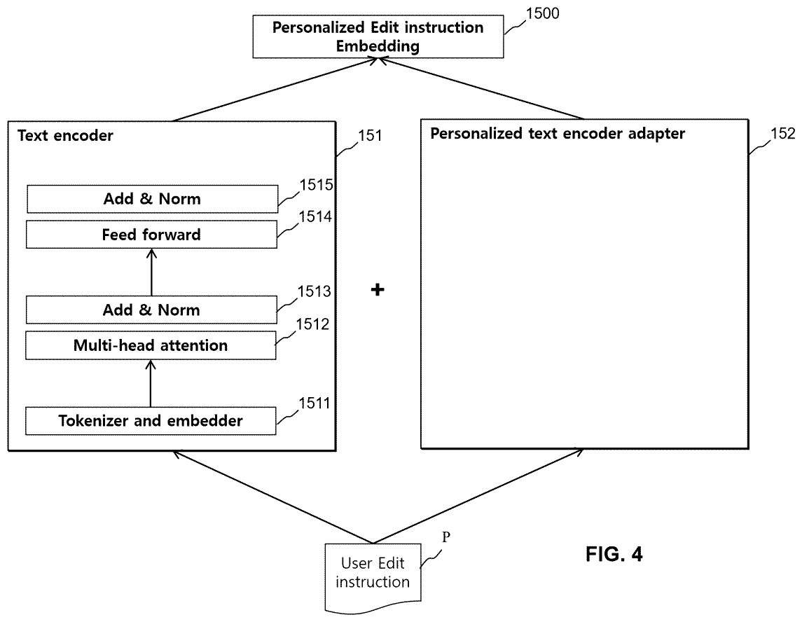

FIG. 4 illustrates a personalized text encoding process according to an embodiment of the present disclosure. The personalized text encoding process illustrates a process of receiving and processing the user edit instruction of a user, that is, the prompt P, through the personalized text encoder 150.

The user edit instruction of the user that is transmitted to the text encoder 151 is first tokenized and embedded by a tokenizer and embedder 1511. Thereafter, information of the user edit instruction is refined through several layers as follows. That is, a multi-head attention layer 1512 extracts important information by simultaneously analyzing text of various parts. An adding and normalization layer 1513 adds and normalizes the results of the extraction of the multi-head attention layer. Next, a feed forward layer 1514 performs more complicated text interpretation. An adding and normalization layer 1515 adds and normalizes the results of the addition and normalization layer.

The user edit instruction of the user is also transmitted to the personalized text encoder adapter 152. In this case, the personalized text encoder adapter 152 converts the user edit instruction into a specialized embedding by incorporating personal characteristics and preference of the user. The embedding is finally output as a personalized user edit instruction embedding 1500. The personalized user edit instruction embedding 1500 is an embedding having a vector form, which is generated to be personalized for the editing intention of the user by recognizing a personal command style through the analysis of the user edit instruction and combining the recognized personalized instruction with an embedding which may be widely applied. The personalized user edit instruction embedding 1500 is used to support personalized image editing based on the user edit instruction of the user.

The text encoding process enables personalized and detailed needs of a user to be accurately understood and incorporated. Accordingly, a finally edited image can more incorporate the user's intention.

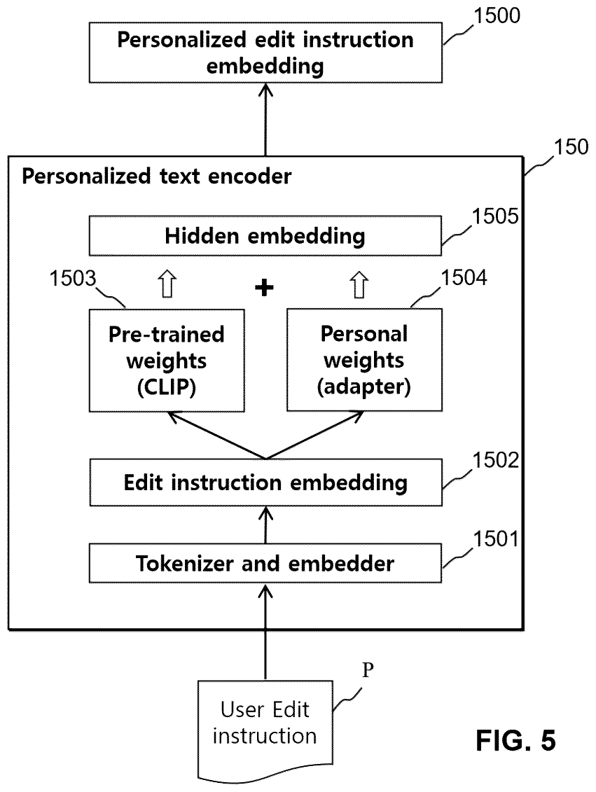

FIG. 5 illustrates a personalized text encoding process using an adapter according to an embodiment of the present disclosure. FIG. 5 illustrates a process of receiving and processing the user edit instruction P of a user through the personalized text encoder 150. The user edit instruction of the user is first tokenized and embedded by a tokenizer and embedder 1501. In a user edit instruction embedding 1502, the tokenized and embedded user edit instruction is converted in an intermediate embedding form in order to understand the meaning of the text.

A path from the user edit instruction embedding 1502 is divided into two paths of a Pre-trained weights unit 1503 and a personal weight unit 1504, and outputs from the user edit instruction embedding 1502 are simultaneously processed. The Pre-trained weights unit 1503 performs common text processing on the output of the user edit instruction embedding 1502 by using an image-text understanding model, such as contrastive language-image pre-training (CLIP). The personal weight unit 1504 embeds the output of the user edit instruction embedding 1502 in personalized text data through an additional adapter layer that incorporates a unique style and preference of the user. Data that are processed in the two paths are integrated in a hidden embedding 1505 and generated as high-level embedding information for more precise text interpretation.

The high-level embedding information is finally output as a personalized user edit instruction embedding 1500. Accordingly, when the personalized user edit instruction embedding is used to generate an image, a personalized image according to a clear editing instruction of a user can be edited. This process provides precise and personalized text interpretation based on a user input, and enables a user's intention and creative demand to be accurately incorporated in final image editing.

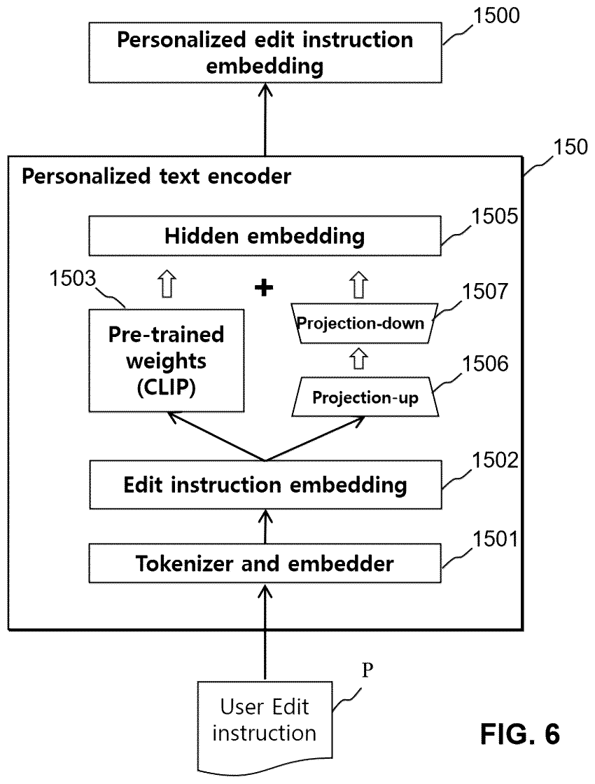

FIG. 6 illustrates a personalized text encoding process to which a tunable model has been applied according to an embodiment of the present disclosure. FIG. 6 illustrates an example in which a tunable model, such as low-rank adaptation of large language models (LORA), has been applied to a personalized text encoder.

The instruction sentence P of a user is first tokenized and embedded in the tokenizer and embedder 1501. Thereafter, in the user edit instruction embedding 1502, the tokenized and embedded user edit instruction is converted in an intermediate embedding form in order to understand the meaning of the text.

The Pre-trained weights unit 1503 performs common text processing on the output from the user edit instruction embedding 1502 by using an image-text understanding model, such as CLIP.

In another path, the text embedding is further subdivided and personalized through a projection-up layer 1506 and a projection-down layer 1507 to which the LORA technology has been applied. The projection-up layer 1506 and the projection-down layer 1507 each provide style information specialized for the user to the embedding of a Pre-trained weights unit 1503, such as CLIP, so that the interpretation of text data can be further personalized.

In the hidden embedding 1505, the embeddings generated as described above are integrated and generated as high-level embedding information for more precise text interpretation. The high-level embedding information is finally output as the personalized user edit instruction embedding 1500. Accordingly, when the personalized user edit instruction embedding is used to generate an image, a personalized image according to a clear editing instruction of a user can be edited. This process provides precise and personalized text interpretation based on a user input, and enables the accurate incorporation of a user's intentions and creative demands into final image editing.

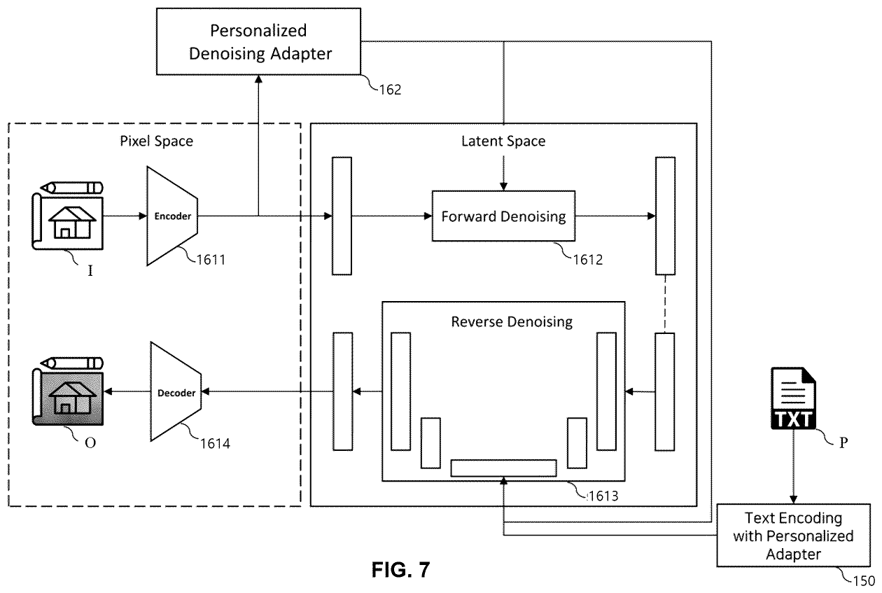

FIG. 7 illustrates an image denoising process according to an embodiment of the present disclosure. In the image denoising process, an input image I provided by a user, that is, an editing target, is received, and the input image in a pixel space is converted into an image in a latent space through an image encoder 1611. The converted latent vector experiences a forward denoising process 1612, and thus noise is gradually applied to the editing image. The personalized denoising adapter 162 uses stored parameters by learning a picture style of a user and a coloring method. In the forward denoising process 1612, the style of the user is incorporated into the editing image.

In a reverse denoising process 1613, the input image is restored to an image having a style desired by the user through a cross-attention mechanism, based on user information into which a personalized image editing command output by the personalized text encoder 150 and the style or preferences of the user, which are stored in the personalized denoising adapter 162, have been incorporated. In the reverse denoising process 1613, an image in the state in which the image substantially does not include noise is output by repeating a step of gradually reducing the noise from the image to which the noise has been added in the forward denoising process 1612 a predetermined number of times or more. Accordingly, a more accurate and personalized style is applied to the input image. A decoder 1614 converts the image in a latent space into an image in a pixel space. A personal picture style of the user is incorporated based on the command through such a process, and thus an edited image O is finally provided to the user.

As described above, text instructions P of the user is encoded in the personalized text encoder 150 using a personalized adapter. The encoded text is applied to the image editing process. All of the processes are designed so that the personal style and creative intention of the user are incorporated into the final image based on the user input. The image editing system proposed through such components realizes personalization, and can effectively perform user-personalized image editing. For example, information stored in the adapter is transmitted to the reverse denoising process 1613 upon inference by using the picture style of an artist and a character coloring method as parameters of the adapter upon learning. Accordingly, an input image can be restored to an editing image desired by a user.

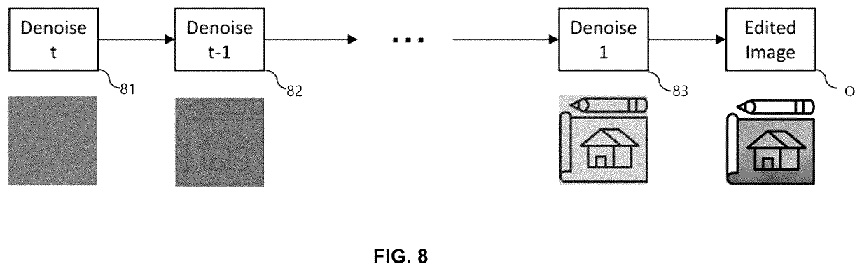

FIG. 8 illustrates a reverse denoising process according to an embodiment of the present disclosure. The reverse denoising process is diagrammed as a process of gradually and clearly processing an image provided by a user through image restoration using several steps of noise removal.

As illustrated in FIG. 8, in an initial step, noise is reduced little by little (82) whenever the noise experiences each step, starting with an image 81 having a very high noise level. This process has an object of restoring the image 81 to an image in the state in which the image rarely includes noise finally (83). In a last step, a finally edited output image O is generated and provided to a user. The output image is an image into which a personalized style and requirements have been incorporated based on the image initially provided by the user and a text command. Each noise removal step functions to elaborately modify and restore a specific style and details through personalized adjustment based on text that is input along with the command of the user.

In particular, the reverse denoising process has been designed to satisfy minute editing needs of a user, and finally provides personalized image editing results. Such reverse denoising image processing supports a user so that the user can finally accurately incorporate a desired image style and contents by subdividing and processing a complicated image restoration and editing process step by step.

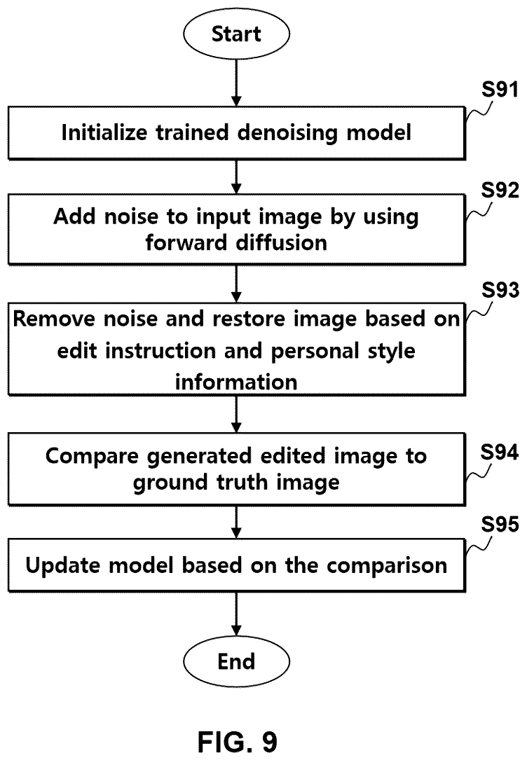

FIG. 9 illustrates a process of training a denoising model according to an embodiment of the present disclosure. First, the trained denoising model is initialized (step S91). Next, noise is added to an input image provided by a user (step S92). A forward diffusion may be used to add the noise to the input image. The forward diffusion adds artificial noise to an image in order to help the denoising model develop a stronger ability to restore noise.

Next, noise is removed and an image is restored based on a user edit instruction and personal style information (step S93). In this step, the denoising model reconstructs an image by incorporating personalized editing based on a text instruction. The reconstructed image is compared with the existing correct answer image (step S94). Through such a comparison, performance of the denoising model may be evaluated, and the learning of an insufficient noise removal function part may be performed. Finally, the denoising model is updated based on the results of the comparison between the generated editing image and an image, that is, a reference (step S95).

Through this process, the denoising model gradually has a more elaborated personalization editing ability, and can more accurately incorporate a style and editing requirements of a user. Such a stepwise approach method plays an important role for the denoising model in learning an editing style of an actual user and developing the ability to reproduce the editing style.

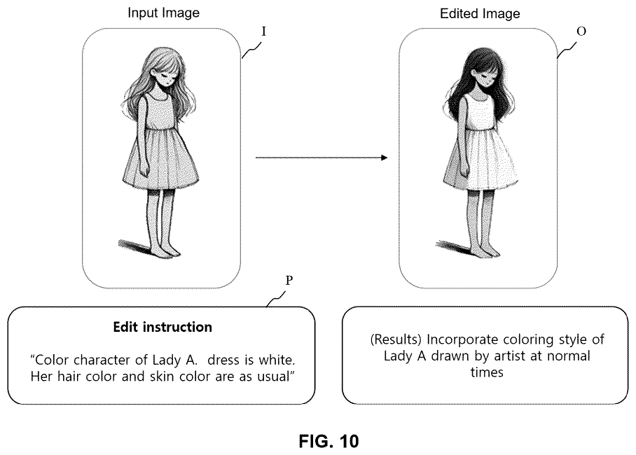

FIG. 10 exemplarily illustrates a concept in which personalized image editing is realized by using an image and a user edit instruction provided by a user according to an embodiment of the present disclosure. In the example of FIG. 10, an input image I is edited according to a user edit instruction P “Color a character of Lady A. The dress is white. Her hair color and skin color are as usual”. The input image I is a sketch image of the character “Lady A”, which is drawn by a webcomic creator. An edited image O is converted into a complete image in which colors are drawn based on the user edit instruction. Furthermore, automatic editing may be performed based on the command “Her hair color and skin color are as usual” upon coloring of “Lady A” only when a picture style that is preferred by an artist is known at normal times.

Conventional technologies have limitations in not sufficiently incorporating a personal unique art style. This results from the characteristics of an image editing model which uses, as learning data, an image that is generated by diffusion based on a natural language instruction generated by a generative language model. The following problems occur due to the characteristics of a model that is trained by such a generalized data set. For example, when a webcomic creator issues an order “Color a character A. Please color hair in red, not black” after sketching a draft of a cartoon, the existing technology, for example, “InstructPix2Pix” has no dictionary knowledge of the character A and is not aware of a specific color sense or scheme that is used when an artist colors red hair at normal times. Accordingly, conventionally, image editing results that are trained through a generalized data set are inevitably used.

In contrast, in an embodiment of the present disclosure, the image editing model has been trained to memorize a personal picture style and to recall and use the personal picture style upon actual inference. Accordingly, even a detailed part of an image can be adjusted by incorporating the editing requirements of a user, and an output into which a user's creative intention and personal style are incorporated can be generated.

The method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

### Description of Reference Numerals

110: processor unit, 120: memory unit, 130: I/O module, 140: learning component, 150: personalized text encoder, 160: personalized denoising model

What is claimed is:

1. An apparatus for automating personalized artificial intelligence image editing, the apparatus comprising:
an input/output (I/O) module configured to receive an input image and a user edit instruction from a user terminal and to output an edited output image;
a personalized text encoder configured to convert the user edit instruction into a personalized image editing command into which personal characteristics and preference have been incorporated; and
a personalized denoising model configured to generate an output image by editing the input image by incorporating the personalized image editing command.

2. The apparatus of claim 1, wherein the personalized text encoder comprises:
a text encoder being a model that understands common text and configured to convert the user edit instruction into the image editing command that is used in the apparatus; and
a personalized text encoder adapter configured to store parameters of personal command styles and to embed, in the image editing command, the personalized editing command into which the personal characteristics and preference have been incorporated.

3. The apparatus of claim 2, wherein the personalized denoising model comprises:
a personalized denoising adapter configured to store user information into which a style or preference of a user have been incorporated; and
a denoising model configured to perform noise removal and image restoration based on the personalized image editing command and the user information.

4. The apparatus of claim 2, wherein the text encoder comprises:
a tokenizer and embedder configured to tokenize and embed the user edit instruction;
a multi-head attention layer configured to extract important information by simultaneously analyzing text of various parts;
an adding and normalization layer configured to add and normalize results extracted in the multi-head attention layer;
a feedforward layer configured to perform more complicated text interpretation;
an adding and normalization layer configured to add and normalize results in the feedforward layer.

5. The apparatus of claim 2, wherein the personalized text encoder comprises:
a tokenizer and embedder configured to tokenize and embed the user edit instruction;
a user edit instruction embedding configured to convert the tokenized and embedded user edit instruction of a user in an intermediate embedding form in order to understand a meaning of text;
a Pre-trained weights unit configured to perform common text processing on an output of the user edit instruction embedding by using an image-text understanding model;
a personal weight unit configured to embed, as personalized text data, the output of the user edit instruction embedding through an additional adapter layer that incorporates a style and preference of a user; and
a hidden embedding configured to integrate data processed by the Pre-trained weights and the personal weight.

6. The apparatus of claim 2, wherein the personalized text encoder comprises:
a tokenizer and embedder configured to tokenize and embed the user edit instruction;
a user edit instruction embedding configured to convert the tokenized and embedded user edit instruction of a user in an intermediate embedding form in order to understand a meaning of text;
a Pre-trained weights configured to perform common text processing on an output of the user edit instruction embedding by using an image-text understanding model;
a projection-up layer and a projection-down layer each configured to have a low-rank adaptation of large language models (LORA) technology applied thereto and to further subdivide and personalize a text embedding; and
a hidden embedding configured to integrate the generated embeddings.

7. The apparatus of claim 3, wherein the denoising model comprises:
an image encoder configured to convert an image in a pixel space into an image in a latent space;
a forward denoising unit configured to gradually apply noise to the converted image in the latent space;
a reverse denoising unit configured to restore the image output by the forward denoising unit to an image into which the personalized image editing command and the user information have been incorporated through a cross-attention mechanism; and
a decoder configured to convert the image output by the reverse denoising unit into an image in the pixel space.

8. The apparatus of claim 7, wherein the reverse denoising unit outputs the image in a state in which the image substantially does not include noise by repeating a step of reducing the noise in the image a predetermined number of times or more.

9. The apparatus of claim 3, wherein the denoising model is trained to have a personalization editing ability through a process comprising steps of:
initializing the trained denoising model,
adding noise to an input image provided by the user,
removing noise and restoring an image based on the user edit instruction and personal style information,
comparing the restored image with an existing correct answer image, and
updating the denoising model based on results of the comparison.

10. A method of automating personalized artificial intelligence image editing, the method comprising:
an input step of receiving an input image and a user edit instruction from a user terminal;
a personalized text encoding step of converting the user edit instruction into a personalized image editing command into which personal characteristics and preference have been incorporated;
a personalized denoising step of generating an output image by editing the input image by incorporating the personalized image editing command; and
an output step of outputting an edited output image.

11. The method of claim 10, wherein the personalized text encoding step comprises:
a text encoding step of converting the user edit instruction into an image editing command that is used in an apparatus as a model that understands common text; and
a step of embedding, in the image editing command, the personalized editing command into which personal characteristics and preference have been incorporated by using a personalized text encoder adapter in which parameters of a personal command style are stored.

12. The method of claim 11, wherein the personalized denoising step comprises performing noise removal and image restoration, based on user information stored in a personalized denoising adapter in which the user information having a style or preference of a user incorporated therein is stored and the personalized image editing command.

13. The method of claim 11, wherein the text encoding step comprises:
a tokenizing and embedding step of tokenizing and embedding the user edit instruction;
a multi-head attention step of extracting important information by simultaneously analyzing text of various parts;
an adding and normalization step of adding and normalizing results extracted in the multi-head attention step;
a feedforward step of performing more complicated text interpretation; and
an adding and normalization step of adding and normalizing results in the feedforward step.

14. The method of claim 11, wherein the personalized text encoding step comprises:
a tokenizing and embedding step of tokenizing and embedding the user edit instruction;
a user edit instruction embedding step of converting the tokenized and embedded user edit instruction of a user in an intermediate embedding form in order to understand a meaning of text;
a step of performing common text processing on an output of the user edit instruction embedding step based on a Pre-trained weights by using an image-text understanding model;
a step of embedding the output of the user edit instruction embedding step as personalized text data based on a personal weight through an additional adapter layer that incorporates a style and preference of the user; and
a hidden embedding step of integrating data processed based on the Pre-trained weights and the personal weight.

15. The method of claim 11, wherein the personalized text encoding step comprises:
a tokenizing and embedding step of tokenizing and embedding the user edit instruction;
a user edit instruction embedding step of converting the tokenized and embedded user edit instruction of a user in an intermediate embedding form in order to understand a meaning of text;
a step of performing common text processing on an output of the user edit instruction embedding step based on a Pre-trained weights by using an image-text understanding model;
a projection-up and projection-down step of further subdividing and personalizing a text embedding by applying a low-rank adaptation of large language models (LORA) technology; and
a hidden embedding step of integrating generated embeddings.

16. The method of claim 12, wherein the personalized denoising step comprises:
an image encoding step of converting an image in a pixel space into an image in a latent space;
a forward denoising step of gradually applying noise to the image converted in the latent space;
a reverse denoising step of restoring the image output from the forward denoising step to an image into which the personalized image editing command and the user information have been incorporated through a cross-attention mechanism; and
a decoding step of converting the image output from the reverse denoising unit into an image in a pixel space.

17. The method of claim 16, wherein the reverse denoising step comprises outputting an image in a state in which the image substantially does not include noise by repeating a step of reducing the noise in the image a predetermined number of times or more.

18. The method of claim 12, wherein:
the personalized denoising step is performed by using a denoising model, and
the denoising model is trained to have a personalization editing ability through a process comprising steps of:
initializing the trained denoising model,
adding noise to an input image provided by a user,
removing the noise and restoring an image based on the user edit instruction and personal style information,
comparing the restored image with an existing correct answer image, and
updating the denoising model based on results of the comparison.
